(19) United States
(12) Patent Application Publication
(10) Pub. No.: US 2015/0373208 A1
(43) Pub. Date: Dec. 24, 2015

(54) SECURE, SCALABLE AND FLEXIBLE INTERNET FAX ARCHITECTURE

(71) Applicant: EC Data Systems Inc., Englewood, CO (US)

(72) Inventors: Christian M. Watts, Aurora, CO (US); Edward D. Shephard, Golden, CO (US)

(73) Assignee: EC Data Systems Inc., Englewood, CO (US)

(21) Appl. No.: 14/313,851

(22) Filed: Jun. 24, 2014

(51) Int. Cl. H04N 1/00; H04N 1/32; H04L 12/58; H04M 7/00

(52) U.S. Cl. CPC H04N 1/001; H04M 7/0024; H04N 1/32416; H04N 1/32422; H04L 51/36; H04N 2201/3209

(57) ABSTRACT

Methods and systems for processing inbound fax messages in a secure, efficient and scalable manner are provided. According to one embodiment, an inbound fax call is received at a telecommunications system of an Internet fax system. The call is switched to a PBX within the system. The call is further switched to a fax server within the system. The fax signal is translated by the fax server into multiple digital representations. Each notification server within the system calculates a load score based on a processor load, a memory load and a number of currently active inbound notification processes. A notification server is selected by the fax server based on the load scores. A subset of the digital representations are delivered to users associated with a subscriber associated with the destination address by the fax server requesting the notification server to perform user notification processing.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2014, EC Data Systems Inc.

### BACKGROUND

1. Field

Embodiments of the present invention generally relate to receiving and processing inbound facsimile messages via email, website and/or custom application programming interface (API) integration. In particular, embodiments of the present invention relate to an improved Internet fax architecture designed for security, scalability, flexibility and efficient inbound facsimile processing that, among other things, isolates fax servers from the Internet, separates facsimile conversion and facsimile notification processing and load balances notification processing.

2. Description of the Related Art

Existing Internet fax systems have numerous limitations in terms of the security and scalability of their architectures. As demonstrated by recently reported data breaches, all devices that access the Internet are vulnerable to attack. As such, fax servers, operating within existing Internet fax systems, that both receive fax calls and deliver email notifications to subscribers are exposed to cyber attacks as a result of requiring Internet connectivity. Existing Internet fax systems also fail to make efficient usage of processing resources, thereby creating bottlenecks in inbound fax processing flow or requiring Internet fax service providers to invest in additional processing resources. Further, flexibility of notification methods is limited by technology that can be implemented on fax servers, which is constrained by compatibility between fax server software/technical requirements and desired notification methods' software/technical requirements.

### SUMMARY

Methods and systems are described for processing inbound fax messages in a secure, efficient and scalable manner. According to one embodiment, an inbound fax call having associated therewith a source address, a destination address and a fax signal is received at a telecommunications system of an Internet fax system. The destination address corresponds to a particular subscriber of the Internet fax system. The inbound fax call is switched to a private branch exchange (PBX) within the Internet fax system. The inbound fax call is further switched to a fax server within the Internet fax system. The fax signal is translated by the fax server into multiple digital representations. Each notification server within the Internet fax system calculates a load score based on a processor load, a memory load and a number of currently active inbound notification processes. A notification server is selected by the fax server based on the load scores. A subset of the digital representations are delivered or otherwise made available to one or more users associated with the particular subscriber as a result of the fax server requesting the selected notification server to perform user notification processing.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a context level diagram illustrating external actors that may interact with an Internet fax system in accordance with an embodiment of the present invention.

FIG. 2 is a system level diagram conceptually illustrating an architecture of an Internet fax system in accordance with an embodiment of the present invention.

FIG. 3 is block diagram illustrating various components of an Internet fax system architecture in accordance with an embodiment of the present invention.

FIG. 4 is block diagram illustrating functional units of a private branch exchange (PBX) in accordance with an embodiment of the present invention.

FIG. 5 is an example of a computer system with which embodiments of the present invention may be utilized.

FIG. 6 is a flowchart illustrating fax call processing in accordance with an embodiment of the present invention.

FIG. 7 is a flowchart illustrating fax processing resource selection in accordance with an embodiment of the present invention.

FIG. 8 is a flowchart illustrating conversion and delivery processing in accordance with an embodiment of the present invention.

FIG. 9 is a flowchart illustrating email delivery processing in accordance with an embodiment of the present invention.

FIG. 10 is a flowchart illustrating fax image storage processing in accordance with an embodiment of the present invention.

FIG. 11 is a flowchart illustrating web delivery processing in accordance with an embodiment of the present invention.

FIG. 12 is a flowchart illustrating API delivery processing in accordance with an embodiment of the present invention.

FIG. 13 is a flowchart illustrating conversion and notification/delivery processing in accordance with another embodiment of the present invention.

FIG. 14 is a flowchart illustrating notification server inbound fax processing in accordance with an embodiment of the present invention.

FIG. 15 is a flowchart illustrating load score calculation processing in accordance with an embodiment of the present invention.

### DETAILED DESCRIPTION

Methods and systems are described for processing inbound fax messages in a secure, efficient and scalable manner. According to embodiments of the present invention, an Internet fax system architecture is provided that, among other novel features, separates facsimile conversion processing from notification processing, thereby providing better scalability and also isolating fax servers from Internet access. Embodiments of the present invention also perform load balancing among notification servers by retrieving load information associated with the notification servers and assigning notification processing to the least loaded notification server.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

For simplicity and sake of brevity, various embodiments described herein focus on inbound fax processing and delivery of received faxes to subscribers; however, it is to be noted that the Internet fax system may also be capable of facilitating sending of outbound fax messages on behalf of subscribers as well.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### TERMINOLOGY

Brief definitions of terms used throughout this application are given below.

The terms “connected” or “coupled” and related terms are used in an operational sense and are not necessarily limited to a direct connection or coupling.

The phrases “facsimile call” or “fax call” generally refer to a call carried over a circuit-switched network (e.g., the public switched telephone network (PSTN)) or a VoIP call carried over a packet-switched network (e.g., the Internet) from a device intending to transmit a facsimile to a particular destination phone number.

The phrases “facsimile processing resource” and “fax processing resource” generally refer to a device capable of answering a facsimile call, establishing a facsimile protocol communication with the caller, receiving facsimile data in an audio format and translating the received audio into a digital representation. A non-limiting example of a facsimile processing resource is a fax server or a subset of resources associated with a fax server. According to embodiments of the present invention, there is no requirement that all fax processing resources be configured the same and/or have the same capabilities or capacity. In one embodiment, such flexibility is enabled by the fact that an appropriate fax processing resource of a set of available fax processing resources may be determined on-the-fly responsive to receipt of an incoming fax call.

The phrases “facsimile signal” or “fax signal” generally refer to a digital representation of audio information encoding a facsimile message. According to embodiments of the present invention, incoming fax signals may be received over a circuit-switched network (e.g., the public telephone network) or a packet-switched network (e.g., the Internet via Voice over Internet Protocol (VoIP)) and delivery of the fax may be to a packet-switched network (e.g., an internal network connected to the Internet). In one embodiment, incoming fax signals contain information regarding the type of network (e.g., packet-switched or circuit-switched), the service provider, a source address and a destination address, thereby allowing processing of the incoming fax signals to be influenced by configuration and/or preference information associated with one or a combination of the source address, the destination addresses, the network and the service provider. For example, the source address and its known capabilities and/or whether the facsimile call arrived over a packet-switched or circuit-switched connection may be used to assign the facsimile call to a particular facsimile processing resource to compensate for the presence or absence of packet delays and jitter. Similarly, the particular source address and destination address combination may have been configured to deliberately use a given type of facsimile processing resource based on known limitations and/or preferences of both the source and destination.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

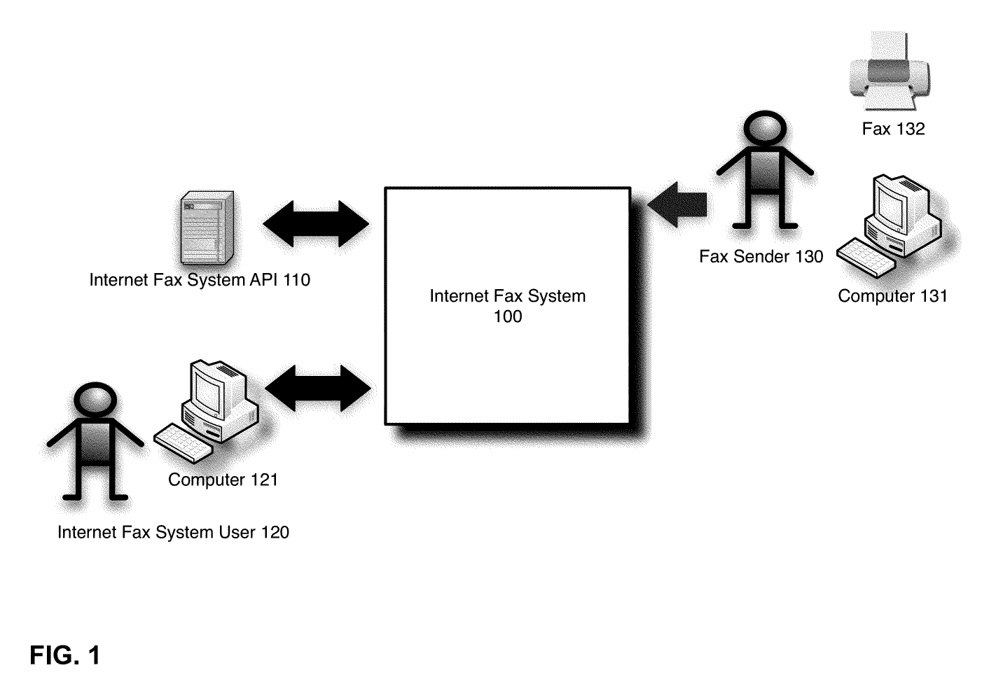

FIG. 1 is a context level diagram illustrating external actors that may interact with an Internet fax system 100 in accordance with an embodiment of the present invention. In embodiments of the present invention, Internet fax system 100 allows users associated with a subscriber account to receive fax messages without necessarily owning a fax machine via a web site, fax to email and/or application programming interface (API) fax methods. Embodiments of the present invention support the notion of a truly multi-user system where the subscriber may be, but is not assumed to be an individual user and is typically an organization having 1 to n users each of which may have access to faxes received on multiple inbound fax numbers. In accordance with various embodiments of the present invention, the notion of a user is effectively decoupled from the destination address (e.g., the inbound fax number) such that a destination address can support 0 to n users and a user can be associated with 0 to n destination addresses.

Each subscriber account may have one or more users and one or more associated fax numbers. According to one embodiment, flexible user configuration settings allow security options, delivery preferences and access privileges to be established with finer resolution than existing fax services. For example, any inbound fax number associated with a subscriber account can be set up to deliver received faxes to any or no user account associated with the subscriber account. As such, multiple inbound fax numbers can be associated with a single user or multiple user accounts rather than being constrained to a one-to-one relationship. For purposes of efficiency, defaults may be established at an account level and overridden, if desired, at the user level. For example, by default all faxes received by a subscribing enterprise may be stored as one or more of portable document format (PDF) files, Joint Photographic Experts Group (JPEG) files, tagged image file format (TIFF) files, ASCII text files, Personal Computer Exchange (PCX) files, DCX file, PostScript files and/or other supported file formats, including, but not limited to, bit map or raster graphics file formats; however, a particular user may specify that faxes delivered to him/her be delivered only in a subset of the supported file formats.

Internet fax system 100 receives and processes inbound fax calls on behalf of subscribers and stores fax images for later retrieval by subscribers and/or forwards the fax images to one or more email addresses designated by the subscribers. Anyone with a fax machine (subscriber or non-subscriber) can dial a subscriber's fax number and Internet fax system 100 will receive the fax, convert/store the fax in a configurable format for later retrieval via the web and/or email the fax to one or more email addresses that can be configured on a per-fax-number basis. As described further below, embodiments of the present invention also allow for data store queries via an API over Hypertext Transport Protocol (HTTP) or HTTP secure (HTTPS) that allows programmers to build fax receive capabilities into their applications.

According to the present example, Internet fax system 100 interfaces with Internet fax system APIs, such as Internet fax system API 110, Internet fax system users associated with a subscriber account, such as Internet fax system user 120, and fax senders, such as fax sender 130.

Internet fax system user 120 may receive inbound fax messages directed to one or more fax numbers associated with an Internet fax subscription via any Internet connected device, such as computer 121, a smartphone (not shown) or the like. As described further below, Internet fax system user 120 may receive faxes as email attachments, as secure download links embedded within email messages or download them from a web site associated with Internet fax system 100. To the extent he/she is authorized to do so, Internet fax system user 120 may also make administrative changes to account settings via the web site, including, but not limited to associating email addresses with fax numbers, specifying fax delivery preferences, designating user access permissions and the like.

Fax sender 130 may send faxes to subscribers of Internet fax system 100 via a dedicated fax machine 132, computer 131, multifunction/all-in-one printer (not shown) or other fax-capable device (not shown) just as he/she would send faxes to non-subscribers. Fax sender 130 need not be a subscriber of Internet fax system 100 to send faxes to a subscriber, such as Internet fax system user 120.

Internet fax system API 110 may represent a standardized API associated with Internet fax system 100 or a custom API developed to API specifications established by the owner/operator of Internet fax system 100. Internet fax system API 110 may provide capabilities that an application programmer can use to integrate fax capabilities into their applications utilizing Internet fax system 100 as a backend, for example. In one embodiment, the integration is accomplished via HTTP or HTTPS POST operations.

Depending upon the particular implementation, Internet fax system API 110 may provide operations to support fax sending and receiving, call detail record collection and automated number provisioning and de-provisioning.

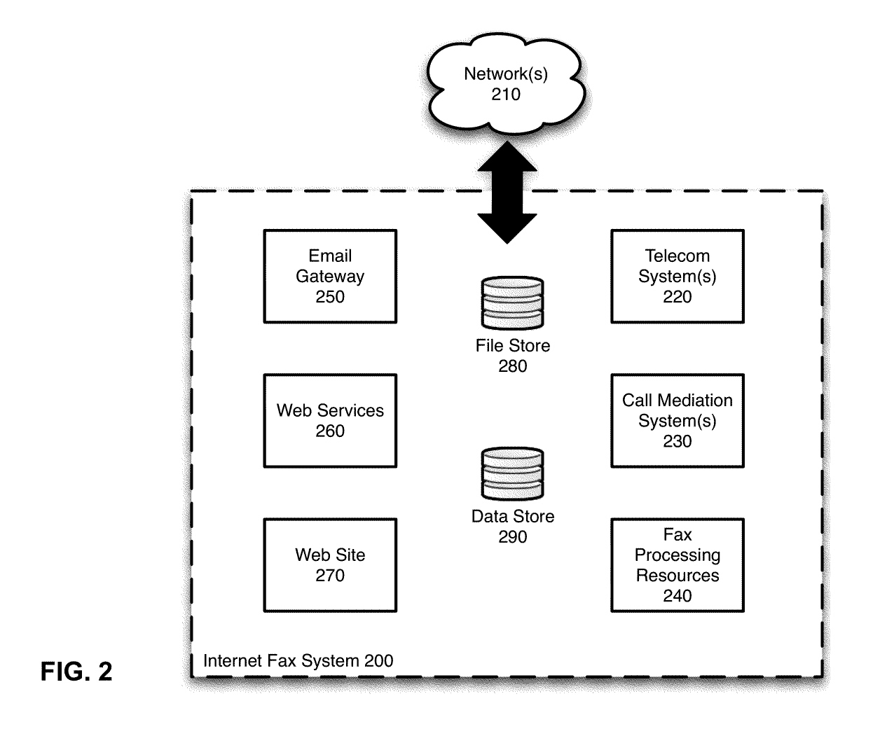

FIG. 2 is a system level diagram conceptually illustrating an architecture of an Internet fax system 200 in accordance with an embodiment of the present invention. According to the present example, Internet fax system 200 is coupled to one or more networks 210 through which inbound faxes may be received and delivered and outbound faxes may be uploaded and transmitted.

In the exemplary simplified architecture depicted, Internet fax system 200 includes one or more telecommunications systems 220, one or more call mediation systems 230, fax processing resources 240, an email gateway 250 a web services interface 260, a web site 270, a file store 280 and a data store 290 interconnected via an appropriate telecommunications signaling network and an Internet Protocol (IP) network.

According to one embodiment, telecommunications system(s) 220 are operable to receive incoming fax calls and pass accepted fax calls to a call mediation system of call mediation system(s) 230. In one embodiment, telecommunications system(s) 220 perform round-robin load balancing among the call mediation system(s) 230. Upon call completion, telecommunications system(s) 220 may record telephony (ISDN) information and call accounting information in data store 290 for billing purposes and/or troubleshooting.

In one embodiment, call mediation system(s) 230 are logically interposed between telecommunications system(s) 220 and fax processing resources 240. Call mediation system(s) 230 receive incoming call information (e.g., caller ID and called number), determine custom call handling based thereon, select an appropriate fax processing resource of those available within fax processing resources 240 and redirect inbound fax calls to the selected fax processing resource. As described further below, load leveling may also be performed at the call mediation layer by preferring not to select the same specific available fax processing resource until all other available and appropriate fax processing resources of fax processing resources 240 have been selected to process an inbound fax call. In some embodiments, call mediation system(s) 230 sit in the path of inbound fax calls and wait for call completion to allow call mediation system(s) 230 to record call accounting for billing in a separate database (not shown). To the extent not performed at the telecommunications system layer, call mediation system(s) 230 may also record telephony (ISDN) information and call accounting information in data store 290 to facilitate troubleshooting.

Fax processing resources 240 are operable to receive incoming call information from call mediation system(s) 230, set custom parameters based on information passed, such as speed/protocol, capabilities, etc., receive inbound fax signals, convert audio fax signals to appropriate digital image form and deliver or otherwise make available the resulting fax messages to one or more users associated with the subscribers to which the inbound faxes are directed (e.g., by storing the fax messages in a destination address-specific storage area within file store 280 for subsequent web retrieval and/or by creating an email message directed to one or more users according to the subscriber's administrative account settings).

According to one embodiment, email gateway 250 is a simple relay operable to receive and send email messages created by fax processing resources 240. In such an embodiment, before sending an email message to email gateway 250 that is to be relayed to a subscriber, fax processing resources 240 may apply custom messaging to the email. For example, fax processing resource 240 may make the email message appear to be from a customer's service provider that operates as a reseller of the Internet fax service or fax processing resource 240 may reformat data in the notification based on customer defined preferences. In alternative embodiments, email gateway 250 may include more intelligence and perform some portion of email creation, customization and/or reformatting.

Web services 260 supports API-based receiving of fax messages, wherein the interaction can be with a program on a user system, as opposed to manual downloading of fax messages by an individual using a web browser as required by existing Internet fax systems, such as that described in U.S. Pat. No. 6,350,066 and its progeny. According to one embodiment, web services 260 is operable to receive request for download of received faxes (e.g., by unique fax ID recorded in data store 290 by fax processing resources 240) via an API call and return fax images to the requesting system. For example, web services 260 may retrieve the fax image location from data store 290, retrieve the fax image from file store 280 and send the fax image to the requesting system over a secure sockets layer (SSL) connection.

Web site 270 is operable to receive and process user requests relating to received faxes. For example, responsive to a user logging into web site 270 and navigating to the receive faxes page, web site 270 may query data store 290 and present the user with an interface, per receiving fax number within the subscriber account with which the logged in user is associated to which the user has access, that lists received faxes. The user may then select a fax to download and cause web site 270 to retrieve the corresponding fax image from file store 280 for download to the user's client system via SSL. In some embodiments, web site 270 may further support the capability for users to rename received faxes to something meaningful to them and/or to create logical “folders” and move faxes' storage presentation from the destination to the logical folder.

File store 280 represents a shared storage resource accessible by fax processing resources 240, email gateway 250, web services interface 260 and web site 270 for storing and accessing digital representations of fax messages. According to one embodiment, file store 280 is simply a disk with no processing other than storage access logic. According to one embodiment, file store 280 is a fax image database implemented within a network attached storage (NAS) device, such as a NetApp NAS filer available from NetApp, Inc.

Data store 290 represents storage for accounting, billing, features and metadata associated with received fax messages. According to one embodiment, data store 290 is a Solaris x86-based workstation running an open source database, such as MySQL.

The centralization of configuration and user information in the manner described above eliminates duplication of such information among inbound fax servers as suggested by prior Internet fax system architectures, such as the architecture described in U.S. Pat. No. 6,208,638. The centralization of storage on a network-shared storage device also eliminates the need for redirecting requests for faxes to a system or program separate and apart from the one (e.g., the web server) the user is communicating with initially to make the request as suggested by prior Internet fax system architectures, such as the architecture described in U.S. Pat. No. 6,350,066. This enhances scalability, flexibility and reliability of the Internet fax system by, among other things, removing the possibility to redirect a request to a server having a problem and in general results in fewer “moving parts” and fewer opportunities for failure.

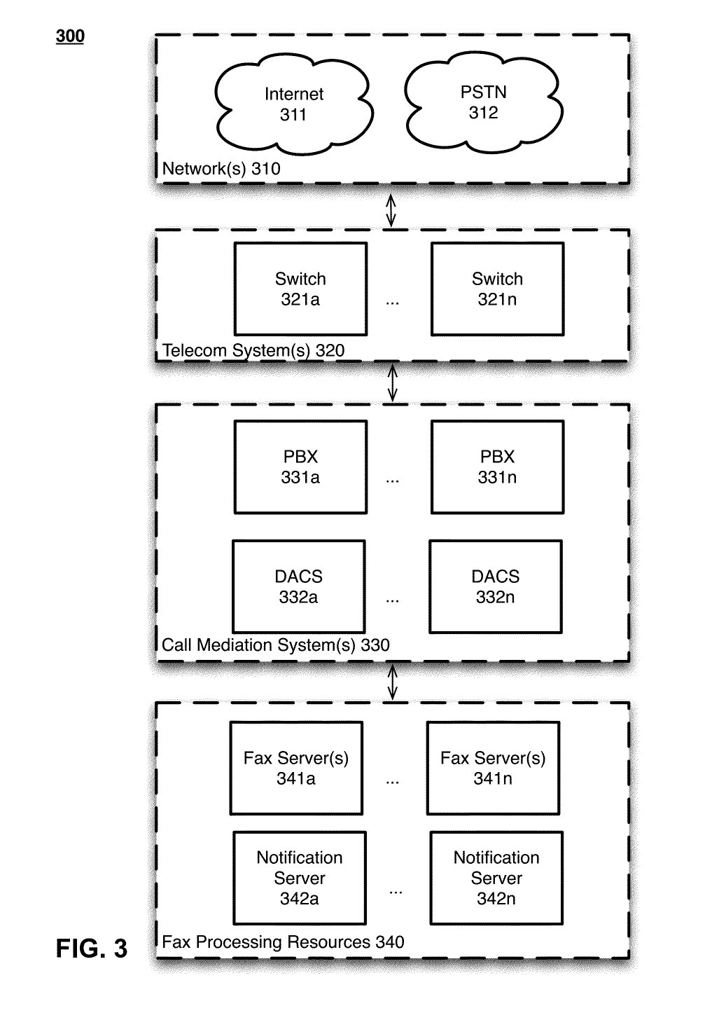

FIG. 3 is block diagram illustrating various components of an Internet fax system architecture 300 in accordance with an embodiment of the present invention. Embodiments of the present invention seek to provide redundancy and scalability based on an active-0/active-n setup of multiple fax servers, PBXs, etc. that are all essentially identical, such that a given fax server does not have to be associated with a “backup” fax server that is used if it goes down as suggested by prior Internet fax system architectures, such as the architecture described in U.S. Pat. No. 6,208,638. Instead, in accordance with embodiments of the present invention, an n-way pool of possible fax servers and modems are available for use and which may be sub-divided by the technical capabilities of each.

In the present example, as in the example architecture discussed with reference to FIG. 2, Internet fax system architecture 300 includes one or more telecommunications systems 320, one or more call mediation systems 330 and fax processing resources 340 coupled to one or more networks 310.

According to the architecture depicted, network(s) 310 may include both a packet-switched network, such as the Internet 311, and a circuit-switched network, such as the public switched telephone network (PSTN) 312. As such, Internet fax system architecture 300 may receive inbound fax calls over packet-switched or circuit-switched connections.

According to the present example, telecommunications system(s) 320 include one or more switches 321a-n. Switches 321a-n may be connected to the Internet via Ethernet and connected to the PSTN 312 via dedicated, high bandwidth circuits (e.g., DS3 and/or DS1 lines). In one embodiment, switches 321a-n are high-capacity access servers providing both packet and time-division multiplexing (TDM) switching. Examples of suitable switches include, but are not limited to, the Cisco AS5850 Universal Gateway, the Cisco AS5800 Access Server, the Cisco AS5400 Universal Gateway, the Cisco AS5350 Universal Gateway and the Cisco AS5300 Universal Access Server. Depending upon the particular implementation, telecommunications system(s) 320 may comprise a single switch or multiple redundant switches in which one of the switches 321a-n is an active primary switch and the others are active standby switches, which can take over for the primary in the event of a failure. In alternative embodiments, it is also possible to have an active/active redundant switch architecture in which multiple circuits from PSTN 312 and/or Internet 311 provide the same services and the circuits are split between multiple switches 321a-n that are interconnected in a mesh for redundancy and/or increased capacity.

Call mediation system(s) 330 may include one or more PBXs 331a-n. In one embodiment analog fax processing resources are supported by providing associated digital access cross connect systems (DACS) 332a-n. PBXs 331a-n may be implemented by installing and running an open source PBX software package on a server. For example, a non-limiting example of a suitable PBX is a Linux server running Asterisk. Alternatively, PBXs available from Cisco or Avaya may be used. According to one embodiment, DACS 332a-n provide DS1/DS0 (0/1) cross-connect functionality and may be one of Adtran's ATLAS series of enterprise integrated access devices, such as the ATLAS 550 series, ATLAS 800 series, Tellabs Titan series DACS or the like.

As described in further detail below, in various embodiments of the present invention, the destination address associated with an inbound fax call may be remapped in a novel manner to force it to be routed to a particular selected analog modem on a fax server where the destination (DID) is changed by the call mediation system to a fixed DID that represents the modem to a DACS in front of the fax server. The destination address is moved into the caller ID name field, while the caller ID number remains the source address.

According to the present example, fax processing resources 340 include one or more fax servers 341a-n and one or more notification servers 342a-n. Each of the fax servers 341a-n may include one or more analog fax modems, digital fax boards and/or soft modems (modems implemented in software). According to one embodiment, fax servers 341a-n each have 24 ports and those ports are connected to the 24 ports of a single DACS of DACS 332a-n. Those of ordinary skill in the art will appreciate there are a variety of possible combinations of DACS to fax server connections/configurations. For example, in alternative configurations, each DACS 332a-n may support multiple fax servers—theoretically as many fax servers as it has ports by connecting each port of the DACS to a single port of a fax server. According to one embodiment, fax servers 341a-n include Linux servers running open source fax server software, such as HylaFAX. As described further below, embodiments of the present invention accommodate facsimile processing resources having different configurations and/or differing capabilities or capacities by dynamically selecting at the call mediation layer appropriate facsimile processing resources based on various factors, e.g., (i) the source address (e.g., automatic number identification (ANI) or caller identification (caller ID, CID)) of the inbound fax call and the source's known capabilities/limitations; (ii) whether the inbound fax call arrived over a packet-switched or circuit-switched connection, (iii) the telecommunications service provider through which the inbound fax call arrived and (iv) the destination address (e.g., Direct Inward Dialing (DID), Dialed Number Identification System (DNIS) or Calling Identification). As such, an Internet fax system architecture in accordance with embodiments of the present invention allows for selection of differing capabilities for inbound modems.

In one embodiment, notification servers 342a-n are used during inbound fax processing to separate image format conversion processing (which may be performed by the fax servers 341a-n) from email notification processing. In alternative embodiments, notification servers may perform both conversion of received fax content (TIFF images) to one or more supported file formats and email notification processing. In both cases, security of Internet fax system 200 is increased by isolating fax servers 341a-n from the Internet.

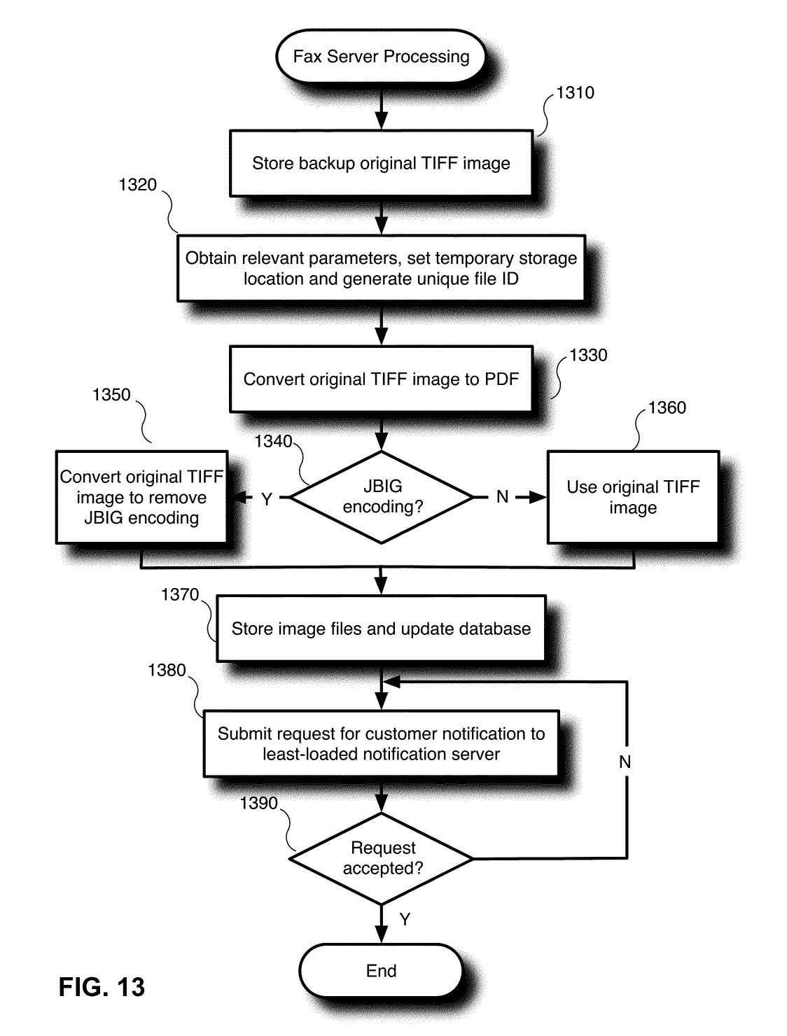

In some embodiments, fax servers 341a-n perform a notification server selection process (e.g., as described further below with reference to FIG. 13) to identify a least loaded notification server of notification servers 342a-n systems 250 to process the fax content. According to one embodiment, after an appropriate notification server has been selected to process the fax content (e.g., perform image format conversion processing and/or email notification processing), the fax server issues a processing request to the selected notification server as described further below with reference to FIG. 13.

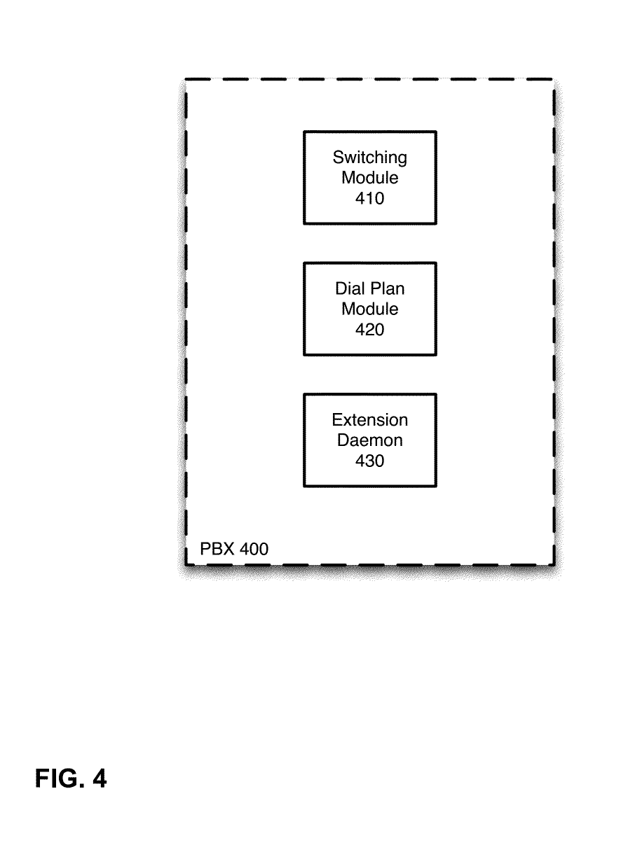

FIG. 4 is block diagram illustrating functional units of a PBX 400 in accordance with an embodiment of the present invention. In the context of the present simplified example, PBX 400 includes a switching module 410 a dial plan module 420 and an extension daemon 430.

According to one embodiment, switching module 410 is responsible, under control of dial plan module 420, for out-dialing on a particular circuit or channel to a destination, then bridging the source call with the destination when the destination answers. Switching module 410 is also typically responsible for reporting the event that the destination answers and/or does not answer to dial plan module 420 for further processing when such event occurs.

Dial plan module 420 is generally responsible for choosing whether to accept or reject a particular inbound fax call, based on source, destination, carrier received on, etc. If the call is accepted, the dial plan module 420 asks extension daemon 430 for an appropriate destination extension to which to switch the call and requests that switching module 410 switch the call to the destination received from extension daemon 430. If switching module 410 indicates that the destination does not answer, then the dial plan module 420 may request extension daemon 430 to identify an alternative destination and attempt to switch the call to the alternative destination until the selected destination answers. Dial plan module 420 may also record call accounting information at call completion for billing purposes.

Extension daemon 430 is responsible for receiving a request for a fax call to be switched from dial plan module 420. The request may include the source address, the destination address and information regarding the carrier/technology from which the call originated. Based on the source, destination, carrier/technology the call comes in on, etc., extension daemon 430 selects a subset of appropriate fax call resources (with the “right” or “desired” capabilities) from all fax call resources. As such, an Internet fax system architecture implemented in accordance with embodiments of the present invention allows for selection of differing capabilities for inbound modems. In any event, from the appropriate fax call resources, extension daemon 430 selects the “next” (according to a round-robin algorithm, for example) fax processing resource that should be tried/used. Extension daemon 430 then returns an extension associated with the selected fax call resource to dial plan module 420.

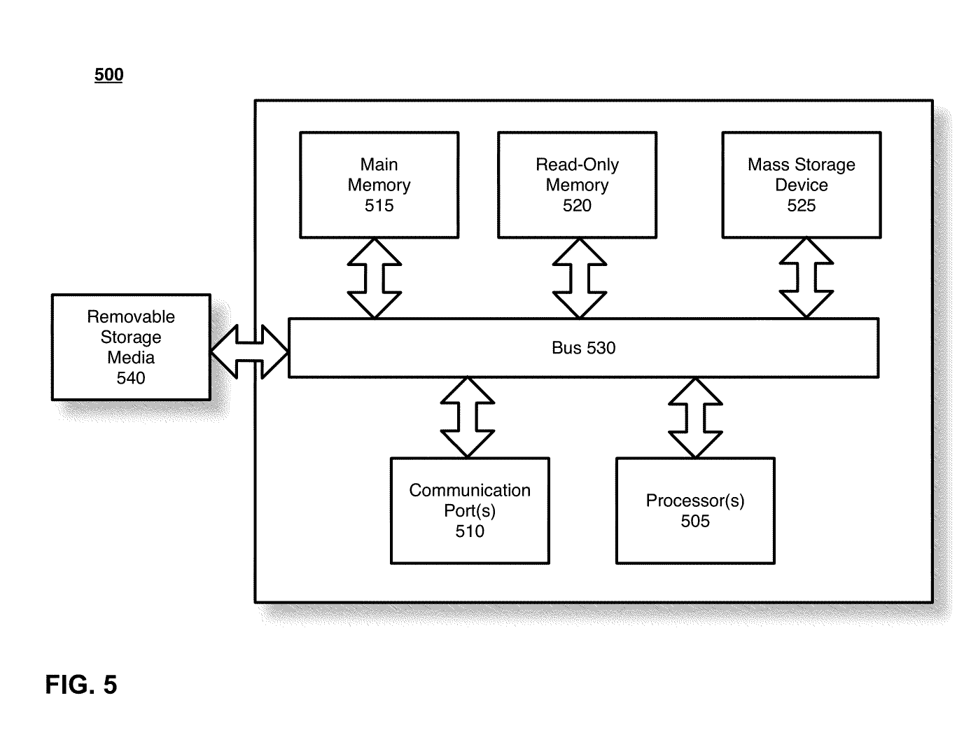

FIG. 5 is an example of a computer system with which embodiments of the present invention may be utilized. Embodiments of the present invention include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As such, FIG. 5 is an example of a computer system 500, such as a Linux-based fax server, a Linux-based PBX, a Solaris x86 database server or the like, upon which or with which embodiments of the present invention may be employed.

According to the present example, the computer system includes a bus 530, one or more processors 505, one or more communication ports 510, a main memory 515, a removable storage media 540, a read only memory 520 and a mass storage 525.

Processor(s) 505 can be any future or existing processor, including, but not limited to, an Intel® Itanium® or Itanium 2 processor(s), or AMD® Opteron® or Athlon MP® processor(s), or Motorola® lines of processors. Communication port(s) 510 can be any of an RS-232 port for use with a modem based dialup connection, a 10/100 Ethernet port, a Gigabit port using copper or fiber or other existing or future ports. Communication port(s) 510 may be chosen depending on a network, such as a Local Area Network (LAN), Wide Area Network (WAN), or any other network to which the computer system 500 connects. For example, in the context of a PBX, communication port(s) 510 may include communication cards supporting Ethernet or DS1/DS3 types of connections and in the context of a fax server, such as one of fax servers 341a-n, communication port(s) 510 may include Ethernet, DS0, T1/DS1 (such as ISDN PRI) or fractional T1/DS1 or digital DS0 (such as ISDN BRI).

Main memory 515 can be Random Access Memory (RAM), or any other dynamic storage device(s) commonly known in the art. Read only memory 520 can be any static storage device(s) such as Programmable Read Only Memory (PROM) chips for storing static information such as start-up or BIOS instructions for processor 505.

Mass storage 525 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 530 communicatively couples processor(s) 505 with the other memory, storage and communication blocks. Bus 530 can include a bus, such as a Peripheral Component Interconnect (PCI)/PCI Extended (PCI-X), Small Computer System Interface (SCSI), USB or the like, for connecting expansion cards, drives and other subsystems as well as other buses, such as front side bus (FSB), which connects the processor(s) 505 to system memory.

Optionally, operator and administrative interfaces, such as a display, keyboard, and a cursor control device, may also be coupled to bus 530 to support direct operator interaction with computer system 500. Other operator and administrative interfaces can be provided through network connections connected through communication ports 510.

Removable storage media 540 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

In some embodiments, a computer system, such as computer system 500, is configured to operate as one or more of PBXs 331a-n. For example, as described above, any or all of PBXs 331a-n may be implemented as a Linux server running an open source PBX software package, such as Asterisk. In some embodiments, a computer system, such as computer system 500, is configured to operate as one or more of fax servers 341a-n. For example, as described above, any or all of fax servers 314a-n may be implemented as a Linux server running open source fax server software, such as HylaFAX. In some embodiments, a computer system, such as computer system 500, is configured to support one or more databases, such as a billing database and/or data store 290. For example, as described above, any or all of the databases described herein may be implemented within a Solaris x86-based workstation running an open source database, such as MySQL. As those of ordinary skill in the art will appreciate, the computer system components described above are meant only to exemplify various possibilities. In no way should the aforementioned exemplary computer system limit the scope of the invention.

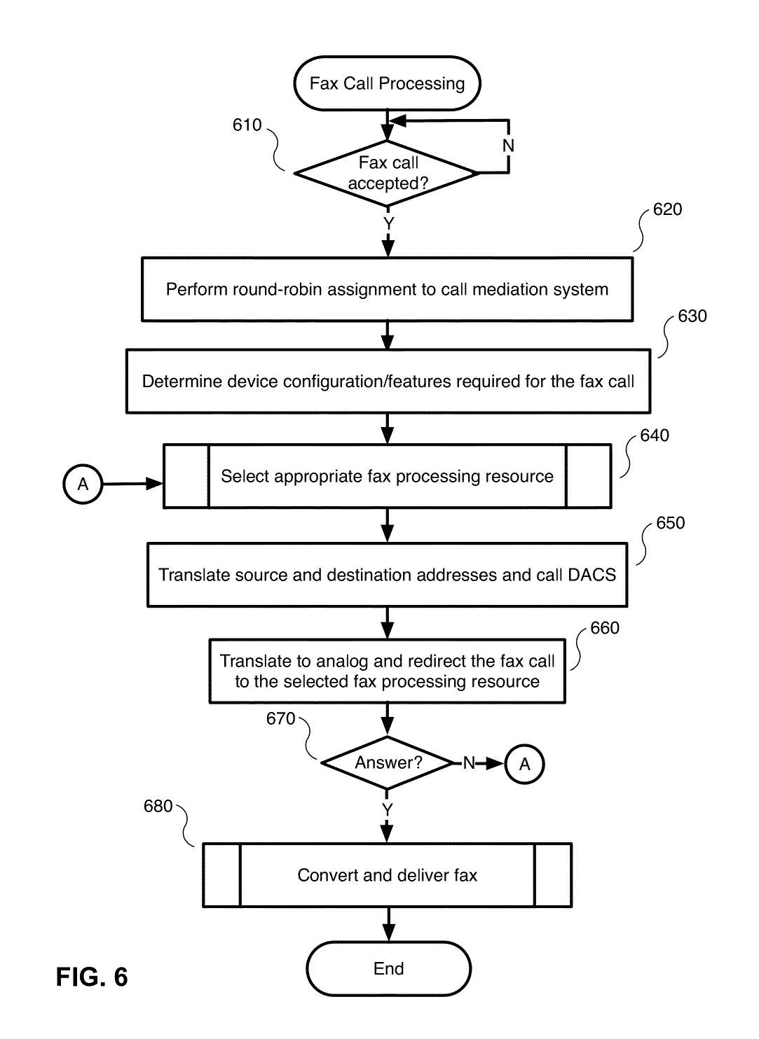

FIG. 6 is a flowchart illustrating fax call processing in accordance with an embodiment of the present invention. At decision block 610, a determination is made regarding whether an inbound fax call has been accepted by the Internet fax system, e.g., by telecommunications system(s) 220 of Internet fax system 200. If so, then fax call processing continues with block 620; otherwise, fax call processing loops back to decision block 610 until an inbound fax call is received.

At block 620, the inbound fax call is assigned to a call mediation system. In one embodiment, a switch, such as switch 321a, performs round-robin load balancing among multiple PBXs, such as PBX 331a-n. In such an embodiment, the switch is stateful as it keeps state regarding which PBX to use next, for example. Those skilled in the art will appreciate that various other load distribution techniques are available. For example, in alternative embodiments, the inbound fax call may be assigned to the least recently used PBX, a randomly selected PBX or PBX having the most available capacity. If guaranteed or differentiated quality of service is offered to subscribers, weighted round-robin or weighted fair queuing may be implemented.

At block 630, device configuration/features required for processing the inbound fax call are determined. According to one embodiment, the PBX to which the inbound fax call has been assigned performs a source address and subscriber account lookup (based on the destination address) in data store 290 to identify configurations or known capabilities/limitations associated with the source and/or the destination of the inbound fax call. For example, the fax transmission source of the inbound call may be known to be capable of high-speed transmission and therefor indicate a preference for a higher speed fax server. Alternatively, the fax transmission source may be known for producing higher than average transmission errors or known to be using an older fax standard, thus indicating a preference for a lower speed fax server.

The PBX may also use information regarding the service provider and/or whether the inbound fax call arrived over a packet-switched or circuit-switched connection to determine configuration/features required for processing the inbound fax call. Based on the various factors, it may be determined, for example, that a fax server that is more tolerant of delays is a feature desirable for processing the particular inbound fax call. Those skilled in the art will appreciate an appropriate data structure can be created and maintained to store and prioritize configuration/feature information based on the above-referenced factors and/or others. For example, a configuration/feature preference associated with a particular network connection (e.g., packet-switched connection) may override and take precedence over a configuration/feature preference associated with one or both of the source address and the destination address of the inbound fax call at issue.

In some embodiments, an inbound fax call may be accepted or rejected by the PBX without performing any further processing based on various factors. For example, the PBX may reject an inbound fax call according to the subscriber's subscribed capacity and how many calls are currently in progress to one or more destination addresses associated with the subscriber. Calls can also be rejected based on the subscriber configuring source addresses (e.g., known fax spammers) from which calls are not to be accepted.

According to one embodiment, as a precondition to performing configuration/feature determination, the PBX may check whether the subscriber to which the inbound fax call is directed is within its subscribed capacity limits (e.g., number of received faxes, total faxes, number of concurrent inbound fax calls, number of received fax pages and/or total fax pages within a predetermined time frame, long distance fees, bandwidth, storage, etc.). If the subscriber is determined to be at capacity, then a busy signal can be returned to the caller. Alternatively or additionally, an inbound fax call may be blocked (by sending a busy signal) at the PBX without passing the call to a fax server based on the source address, the destination address or a combination of the two addresses. Source-address-only blocking may be performed system wide for all subscribers and all destinations. In one embodiment, an inbound fax call may be blocked based on a combination of the source address and the subscriber. That is, subscribers of the Internet fax system may be provided with the capability to block a source to just one of their numbers or to all of their numbers, including numbers to which they subscribe in the future; the block being based on source/subscriber combination accomplishes this. In one embodiment, the PBX remains in the path of the call and waits for the call to be completed so it can record call accounting for billing in a billing database. In one embodiment, at the time of the inbound call event and prior to call completion, source and destination address configurations are checked, but the centralized resource for user account information is not.

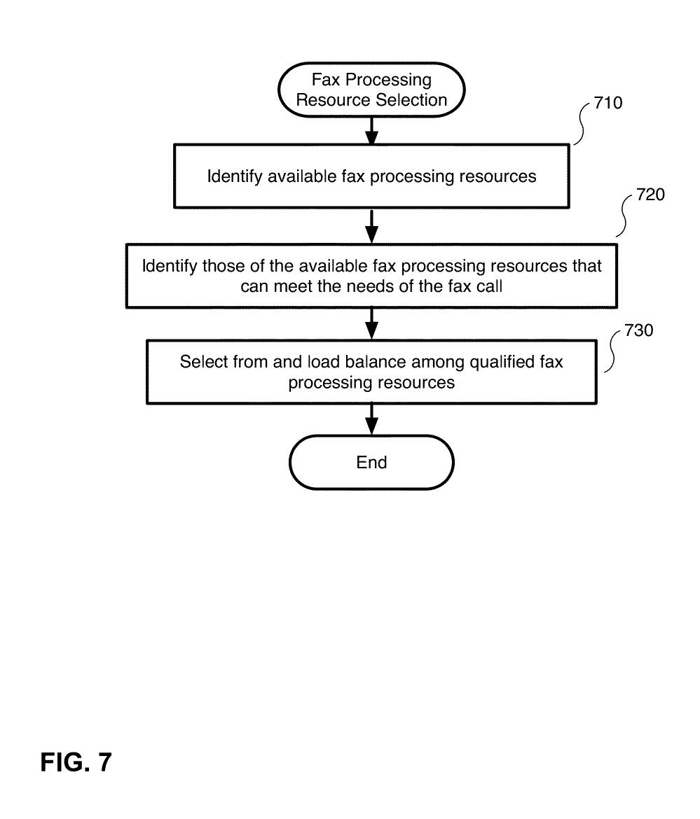

At block 640, to the extent the inbound fax call is to be passed to a fax processing resource, an appropriate fax processing resource is selected. According to one embodiment, appropriate fax processing resource selection proceeds as described with reference to FIG. 7.

At block 650, the source and destination addresses associated with the inbound fax call are translated and the appropriate DACS is called. According to one embodiment, the PBX places the DNIS into the calling name and changes the DNIS to the extension of the selected fax processing resource prior to calling the DACS. Those skilled in the art will be familiar with various conventions/schemes for assigning extensions to DACS and fax servers in the exemplary architecture depicted in FIG. 3. In one embodiment, each PBX is associated with one or more DACS each having 24 fax ports and the extensions have the following format:

303303DDFF

Where:
the first six digits (i.e., 303303) are hard-coded
DD represents the DACS with which the selected fax server is associated
FF represents the fax port on the DACS to which the selected fax server is connected.

At block 660, the inbound fax call is translated to analog and redirected to the selected fax processing resource. In one embodiment, the DACS redirects the incoming call signal along with the source and destination addresses, to the selected fax processing resource, as specified in the destination address specified by the call mediation system to the message processing resource via a circuit switched connection, translating the ANI into caller ID name (containing the original destination address) and number (containing the source address) fields. According to one embodiment, the DACS redirects the inbound fax call to the port number represented by the last two digits of the DNIS of the inbound fax call.

At decision block 670, it is determined whether the selected fax processing resource answered the call. If so, then fax call processing continues with block 680; otherwise, fax call processing loops back to block 640 and a different fax processing resource is selected.

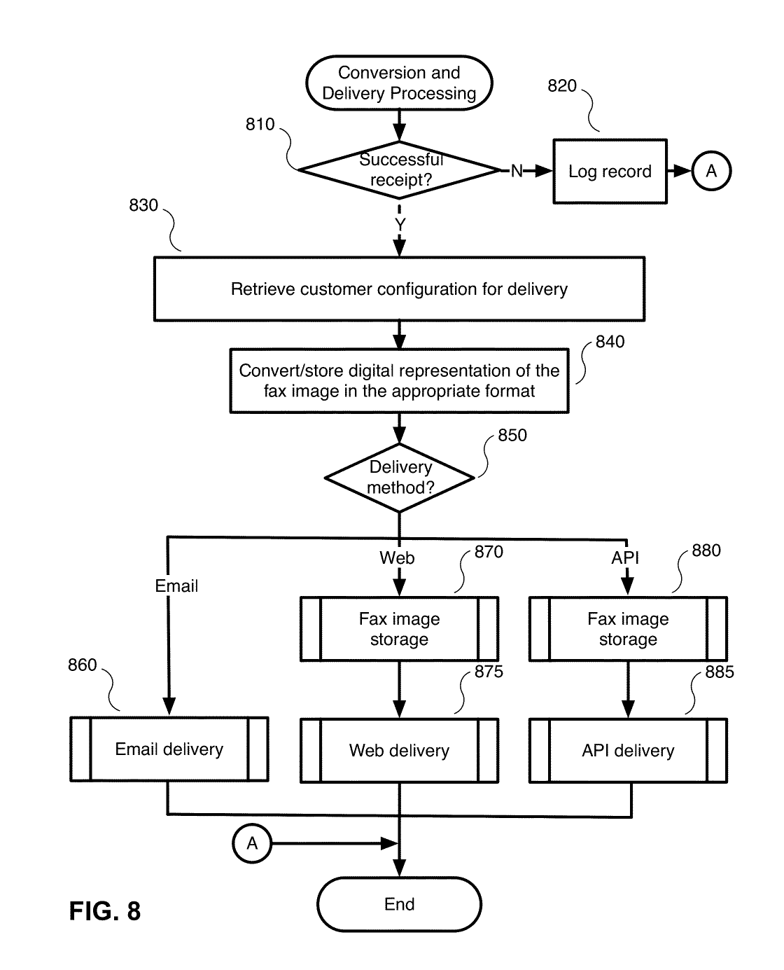

At block 680, the inbound fax signal is converted to a fax image and delivered and fax call processing is complete. According to one embodiment, conversion and notification/delivery of the fax proceeds as described with reference to FIG. 8. In other embodiments, conversion and notification/delivery of the fax proceeds as described with reference to FIG. 13.

FIG. 7 is a flowchart illustrating fax processing resource selection in accordance with an embodiment of the present invention. In one embodiment, the steps described with reference to FIG. 7 are performed within block 640 of FIG. 6.

At block 710, available fax processing resources are identified. According to one embodiment, a database exists within the Internet fax system that maintains information identifying (i) all fax processing resources within the Internet fax system, (ii) the DACS and port number with which each fax processing resource is associated and (iii) features of each fax processing resource. The PBX may identify the universe of fax processing resources available to it by obtaining information from the database relating to fax processing resources associated with one or more DACS connected to the PBX.

In some embodiments, the PBX may maintain information regarding those fax processing resources that are ready to accept a call based on device status information periodically provided to the PBX by its associated fax processing resources. In other embodiments, the PBX may request device status information as needed from its associated fax processing resources or query the status from a database that maintains such information. In an environment in which device status is available to the PBX, the PBX may retrieve from the database feature information for only those fax processing resources known to currently be ready to accept a call.

At block 720, those of the available fax processing resources that can meet the needs of the inbound fax call are identified. According to one embodiment, the list of available fax processing resources generated in block 710 is pruned to produce a list of qualified fax processing resources by excluding those fax processing resources that are incapable of handling the fax speed and/or other capabilities deemed to be required to processing the fax signal associated with the inbound fax call.

At block 730, an appropriate fax processing resource is selected from the list of qualified fax processing resources. According to one embodiment, load balancing is performed among those of the qualified fax processing resources by performing a least recently used selection algorithm or the like. For example, the PBX may avoid selection of a previously selected fax processing resource until all other fax processing resources on the list of qualified fax processing resources have been subsequently selected to process an inbound fax call.

FIG. 8 is a flowchart illustrating conversion and delivery processing in accordance with an embodiment of the present invention. In one embodiment, the steps described with reference to FIG. 8 are performed within block 680 of FIG. 6.

At decision block 810, a determination is made regarding whether the fax signal associated with the inbound fax call was successfully received. According to one embodiment, successful receipt means receipt of all pages encoded within the fax signal and proper completion of all phases of the fax protocol. If it is determined that fax signal has been successfully received, then conversion and delivery processing continue with block 830; otherwise, conversion and delivery processing branch to block 820.

At block 820, detailed information regarding the inbound fax call and the associated fax signal can be stored in a log to facilitate subsequent troubleshooting.

At block 830, subscriber account information is retrieved to obtain delivery preferences/configuration for the fax based on the fax number dialed. In embodiments of the present invention, each subscriber may have one or more fax numbers and each fax number may have zero or more authorized users.

At block 840, based on the subscriber's established preferences, the received fax may be converted from TIFF format to any of a number of supported formats, such as PDF format, and stored for retrieval via the web or API. According to one embodiment, received faxes are stored based on their destination address, not by user thereby supporting the notion of a truly multi-user system in which the subscriber is not an individual user, but rather is an organization having multiple users. In this manner, multiple users may be authorized to access and/or delete faxes received on a particular fax number.

At decision block 850, the delivery method is determined. According to one embodiment, various configurable delivery preferences include, one or more of a preferred image file format (e.g., TIFF or PDF), delivery method and zero or more authorized users and associated access rights (e.g., read only, read/delete). Exemplary delivery methods include retrieval via a web site associated with the Internet fax server, retrieval via API, delivery of an email notification with an embedded link from which the fax can be retrieved or delivery of the fax as an email attachment (with or without password protection or PGP encryption).

Depending upon the particular implementation, the delivery method may be established at the subscriber level, the fax number level and/or the user level. For sake of brevity and simplicity, in the present example, it is assumed that a delivery method is established at the subscriber level or the fax number level. As such, in accordance with the present example, each user designated to receive a copy of faxes received on the particular fax number will receive the fax in the same form and via the same delivery method. If the delivery method is email, then conversion and delivery processing continues with block 860. If the delivery method is web, then processing continues with block 870. If the delivery method is API, conversion and delivery processing continues with block 880. Those skilled in the art will recognize various other delivery methods, including, but not limited to, text message notification, instant message notification, pager notification, notification via automated voice call and the like.

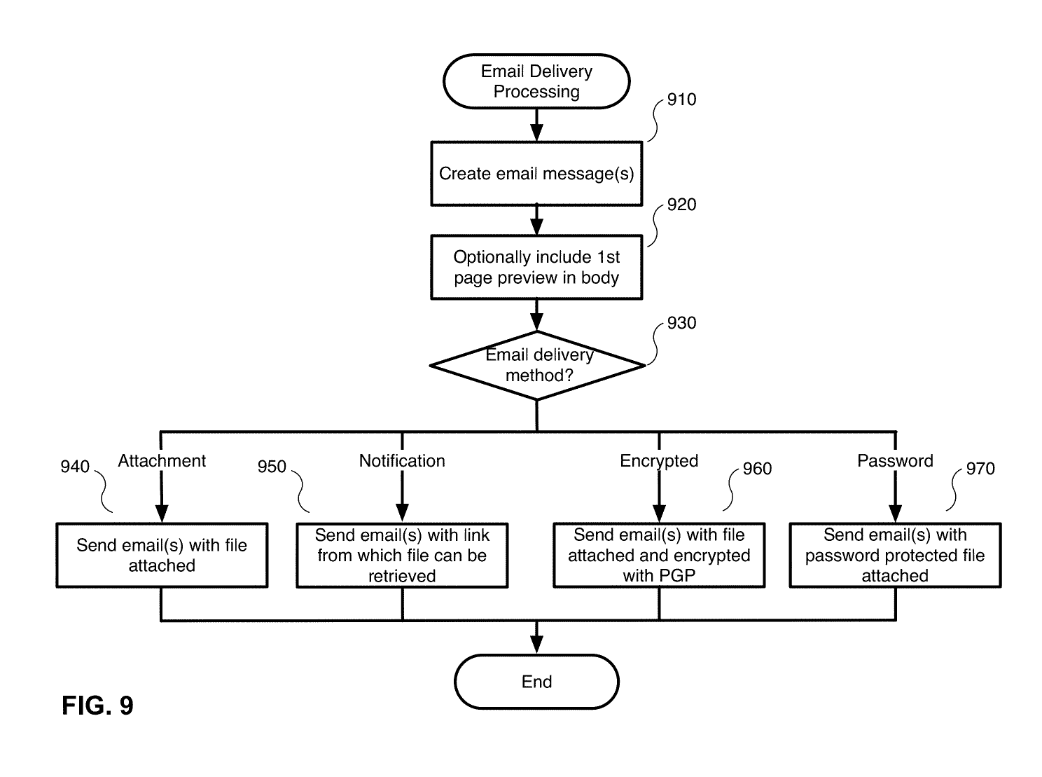

At block 860, the fax message is delivered via email to the designated users. Depending upon the particular implementation, a copy of the fax image may or may not also be stored within the Internet fax system. According to one embodiment, email delivery proceeds as described with reference to FIG. 9. Upon completion of the email delivery, conversion and delivery processing is complete.

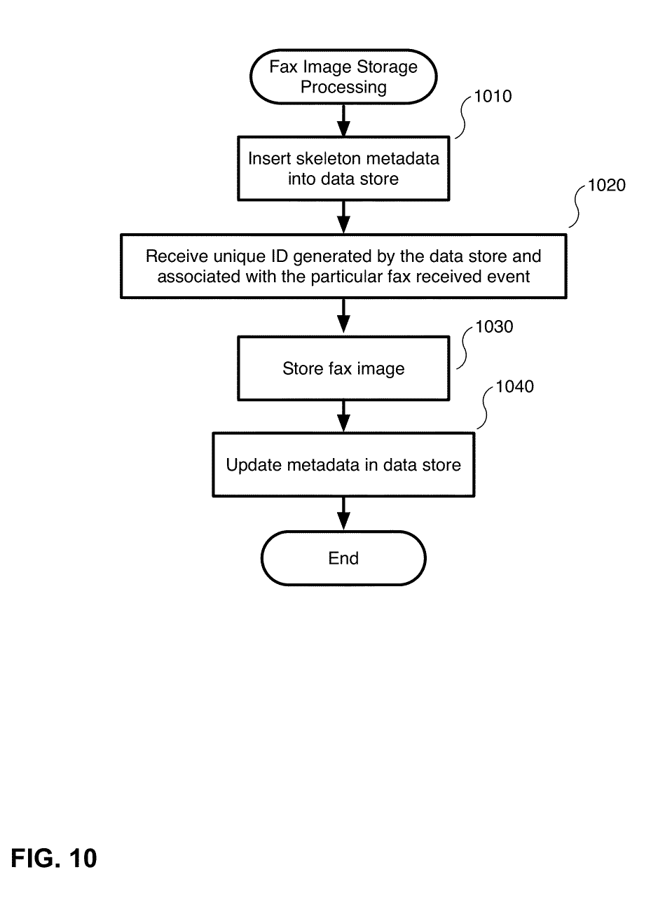

At block 870, the fax image is stored within the Internet fax system to make it available for access to authorized users. According to one embodiment, fax image storage proceeds as described with reference to FIG. 10.

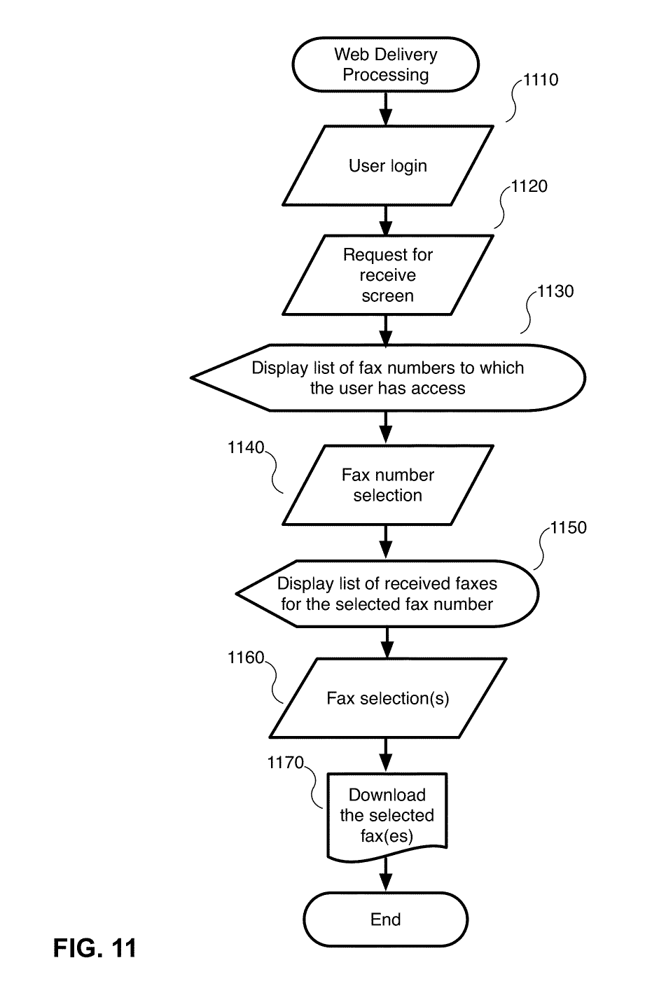

At block 875, delivery of the fax image is performed via a web delivery mechanism. According to one embodiment, fax image storage proceeds as described with reference to FIG. 11. Upon completion of the web delivery, conversion and delivery processing is complete.

At block 880, the fax image is stored within the Internet fax system to make it available for access to authorized users. According to one embodiment, fax image storage proceeds as described with reference to FIG. 10.

At block 885, delivery of the fax image is performed via an API delivery mechanism. According to one embodiment, fax image storage proceeds as described with reference to FIG. 11. Upon completion of the API delivery, conversion and delivery processing is complete.

While in the context of the present example, fax image storage is shown as taking place for only the web and API delivery methods, in one embodiment, fax image storage may take place for all delivery methods.

For simplicity FIG. 8 shows the delivery method determination being performed only once; however, it is to be understood that decision block 850 may be placed within a loop to allow a delivery method determination to be made for each user to which a received fax is to be delivered. For example, embodiments of the present invention may provide highly customizable delivery options. According to one embodiment, delivery preferences can be configured at one or more levels of the hierarchy (e.g., the subscriber level, the fax number level and/or the user level) with preferences defined at lower levels of the hierarchy overriding preferences (defaults) established at higher levels of the hierarchy. As such, a received fax may be delivered to multiple users via different delivery methods. For example, a subscriber's default delivery preferences may be web delivery (e.g., retrieval via a web site associated with the Internet fax system) in PDF form with delivery to users A, B, C and D. Meanwhile, a particular fax number associated with the subscriber may be configured via delivery preferences to deliver a copy of all received faxes to users A, B and C, but not D. Furthermore, users A and B may have individually established delivery preferences, such as email notification and email delivery via password protected PDF, respectively. In such a configuration, all faxes received on the particular fax number will be delivered to users A, B and C (but not user D) by causing an email notification to be sent to user A, causing an email with a password protected PDF containing an image of the received fax to be sent to user B and causing a copy of the received fax to be stored, e.g., in file store 280, that is accessible via the web site by user C.

While for simplicity FIG. 8 treats the successful receipt determination (i.e., decision block 810) as an all or nothing proposition (i.e., either the entire fax is received successfully or it is considered a failure), in other embodiments, partial fax receipt may be accommodated via an associated delivery preference specifying whether partial faxes should be delivered and if so by logging the partial receipt and treating the partial receipt as a successful receipt for purposes of decision block 810. In some embodiments, the partial delivery (on or off) preference may be supported only as a per-destination preference (not per-subscriber or per-user). Similarly, partial delivery may be supported for only a limited number of the delivery methods (e.g., email and API delivery, but not web delivery).

FIG. 9 is a flowchart illustrating email delivery processing in accordance with an embodiment of the present invention. In one embodiment, the steps described with reference to FIG. 9 are performed within block 860 of FIG. 8.

At block 910, one or more email messages are created directed to the users designated to receive a copy of received faxes for the fax number at issue. Depending upon the particular implementation, a single email message can be created directed to all users designated to receive a copy of received faxes for the fax number at issue. Alternatively, flexibility can be enhanced by creating separate email messages for each designated user in accordance with their specific delivery preferences. In some embodiments, the fax server or email gateway may apply custom messaging to the email message to make the email message appear to be from a customer's service provider that operates as a reseller of the Internet fax service, for example. Alternatively, the email message may be otherwise reformatted based on customer-defined preferences.

According to one embodiment, post-processing custom messaging/email capabilities may be provided on a per-subscriber and per-user within the subscriber basis in order to support, among other things, re-sale of the fax service and custom parsing requirements the user's system (if they parse email with a program) may have, such as subject line sorting in a way that works for the user in their email client (e.g., putting the number from which the fax was received at the beginning of the subject line (or the date and time or the page count or whatever) so the user can sort and find faxes in the context of their email client (e.g., Microsoft Outlook or the like) easily by subject line)

At block 920, a preview of the first page of the fax may be embedded inline within the email message. According to one embodiment, the preview may be embedded in the form of a reduced size thumbnail image of the first page of the fax. In some embodiments, the preview may include more than one page.

At decision block 930, the specific email delivery method is ascertained. Numerous email delivery and notification methods are contemplated. For purposes of simplicity, the present example, illustrates processing relating to unencrypted email attachment, email notification, encrypted email attachment and password-protected email attachment. If the email delivery method is attachment, the email delivery processing continues with block 940. If the email delivery method is notification, then email delivery processing continues with block 950. If the email delivery method is encrypted, processing continues with block 960. If the email delivery method is password, then email delivery processing continues with block 970.

At block 940, the one or more generated email messages are sent with an attachment in the previously determined desired image file format.

At block 950, the one or more generated email messages are sent with a link from which the fax image can be retrieved. According to one embodiment, the link is a secure link that uses SSL to transmit the fax image.

At block 960, the one or more generated email messages are sent with an attachment in the form of an image file encrypted with PGP.

At block 970, the one or more generated email messages are sent with an attachment in the form of a password-protected image file, such as a password-protected PDF.

For simplicity FIG. 9 shows the email delivery method determination being performed only once; however, it is to be understood that decision block 930 may be placed within a loop to allow an email delivery method determination to be made for each user to which a received fax is to be delivered in a manner similar to that described with reference to FIG. 8. As such, each user designated to receive an email delivery/notification may have such email delivery/notification delivered in accordance with their particular preferences.

FIG. 10 is a flowchart illustrating fax image storage processing in accordance with an embodiment of the present invention. In one embodiment, the steps described with reference to FIG. 10 are performed within blocks 870 and 880 of FIG. 8.

At block 1010, skeleton metadata is inserted into data store 290. According to one embodiment, the skeleton metadata is a subset of the metadata (e.g., excluding the associated directory path as it has yet to be determined) associated with the received fax and is inserted by the fax server. In one embodiment, responsive to the insertion data store 290 returns to the fax server a unique ID (e.g., a fax ID of 1 to n digits) to be associated with this particular fax received event. According to one embodiment, the fax ID is based on an auto-incremented unique primary key.

At block 1020, the unique ID generated by data store 290 is received by the fax server.

At block 1030, the fax image is stored. According to one embodiment, the fax image is stored within the file store 280 in a directory path that is based at least in part on the fax ID. In one embodiment, if an appropriate directory has not already been created, logic implemented within the fax server may create a directory on the file store 280 in accordance with the following convention, for example:

/export/Infaxes/ZZZZ/YYYY-MM-DD/VVVV

Where:
/export/Infaxes/ is fixed (this is where the NFS file store is mounted)
ZZZZ represents the ID associated in the database with the destination number (can be 1 to n digits long)
YY-MM-DD represents the current year/month/day
VVVV represents the unique ID associated in the database with this particular fax received event (can be 1 to n digits long)

At block 1040, metadata regarding the received fax is updated, for example, to include the (now known) directory path. According to one embodiment, the metadata includes:
1. A system-established unique identifier for this received fax
2. A numeric identifier corresponding to the destination number on which the fax was received
3. A system-established unique identifier for the file that contains the image of the fax (e.g., the PDF or TIFF image)
4. The date and time the fax was received
5. The data and time at which the call resulting in the received fax began
6. The caller ID or “source” or “source address” of the call
7. The number of pages in the image
8. The subscriber (not the user) for whom the fax is addressed
   Additional metadata (in other related tables by the corresponding numeric identifiers) may include:
   For #2 above:
The phone number or destination address associated with the destination that the fax was received on, which subscriber that phone number belongs to.
   For #3 above
A physical storage location associated with the file id.
Either of a destination or a logical folder (user created) in which the file currently resides.
A system generated unique file name for the file, which may be used when the user downloads it. The user can also rename the file either when it is residing in the destination number or when it is residing in a folder. An example system-generated name would be along the lines of fax012345.pdf.

FIG. 11 is a flowchart illustrating web delivery processing in accordance with an embodiment of the present invention. In one embodiment, the steps described with reference to FIG. 11 are performed within block 875 of FIG. 8. For simplicity, only a subset of interactions with the web site are depicted in FIG. 11—those relating to retrieval of a received fax.

At block 1110, a customer logs in via a web site, e.g., web site 270, associated with the Internet fax system. According to one embodiment, each user associated with a subscriber is assigned a user name and password.

Assuming the user is logging into the web site to view and/or retrieve received faxes, at block 1120, a request for the receive page is received from the user.

Concurrently with displaying of the receive page, at block 1130, a list of fax numbers to which the user has access is displayed (which might be a subset of all fax numbers associated with the subscriber or even none).

At block 1140, the user selects a fax number from the list of fax numbers and the fax number selection is received by a web server associated with the Internet fax system.

At block 1150, responsive to the fax number selection, a list of received faxes for the selected fax number is displayed. Depending upon the particular implementation, received faxes may be selectively displayed in ascending or descending order according to the time and date received. Received faxes may also be sorted based on the source address and/or based on whether the received fax has already been viewed or downloaded.

At block 1160, the user selects a fax from the list of received faxes and the fax selection is received by the web server.

At block 1170, the selected fax is downloaded to the client system being used by the user. Various other interactions relating to administrative settings and receiving, sending and/or organizing faxes may be supported by the web site interface. For example, as described above, web site 270 may support the renaming of faxes and the creation and use of logical folders to organize sent and/or received faxes.

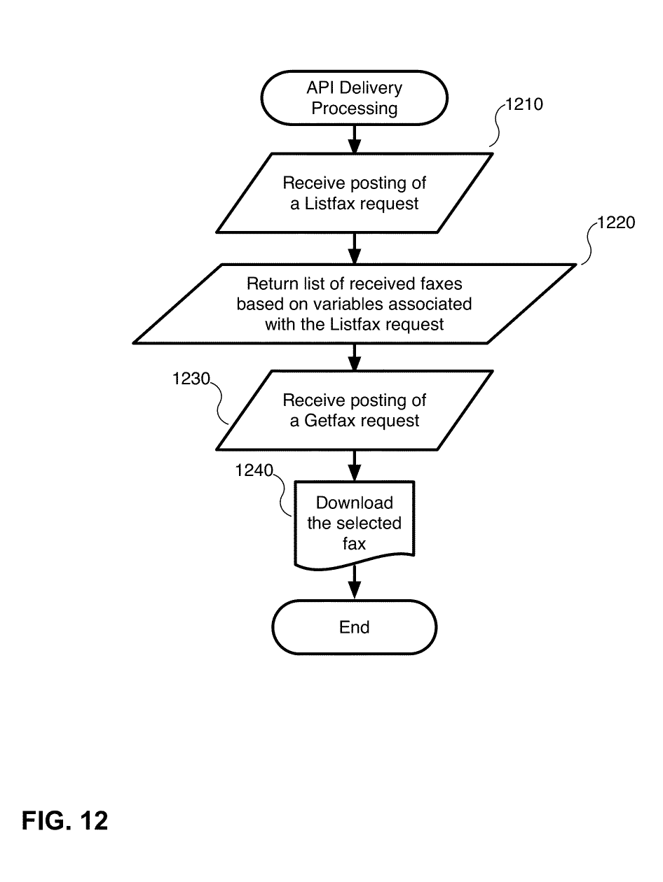

FIG. 12 is a flowchart illustrating API delivery processing in accordance with an embodiment of the present invention. In one embodiment, the steps described with reference to FIG. 12 are performed within block 885 of FIG. 8. For simplicity, only a subset of interactions with a web services interface, e.g., web services 260, are depicted in FIG. 12—those relating to retrieval of a received fax.

At block 1210, a subscriber application posts a Listfax request to the Internet fax system web services interface, e.g., web services 260 via HTTP or HTTPS. According to one embodiment, the Listfax request allows for programmatic listing of currently received faxes. For purposes of maintaining security consistent with access via the web site, the Listfax request may require, among other information, the company credential associated with the subscriber as assigned by the Internet fax system, a user name associated with the subscriber as assigned by the Internet fax system and the password associated with the user making the request. Various other POST variables include, but are not limited to, a begin variable, which allows the subscriber application to retrieve faxes received after the specified date/time.

Responsive to the Listfax request, at block 1220, a list of received faxes, including corresponding fax IDs, are returned to the subscriber application based on the variables associated with the Listfax request.

At block 1230, the subscriber application posts a Getfax request to the Internet fax system web services interface via HTTP or HTTPS. According to one embodiment, the Getfax request allows for programmatic downloading of a received fax. As above, for purposes of maintaining security consistent with access via the web site, the Getfax request may require, among other information, the company credential, a user name and the password associated with the user making the request. In one embodiment, the fax ID of the desired fax is a required POST variable.

At block 1240, the selected fax is downloaded to the subscriber application.

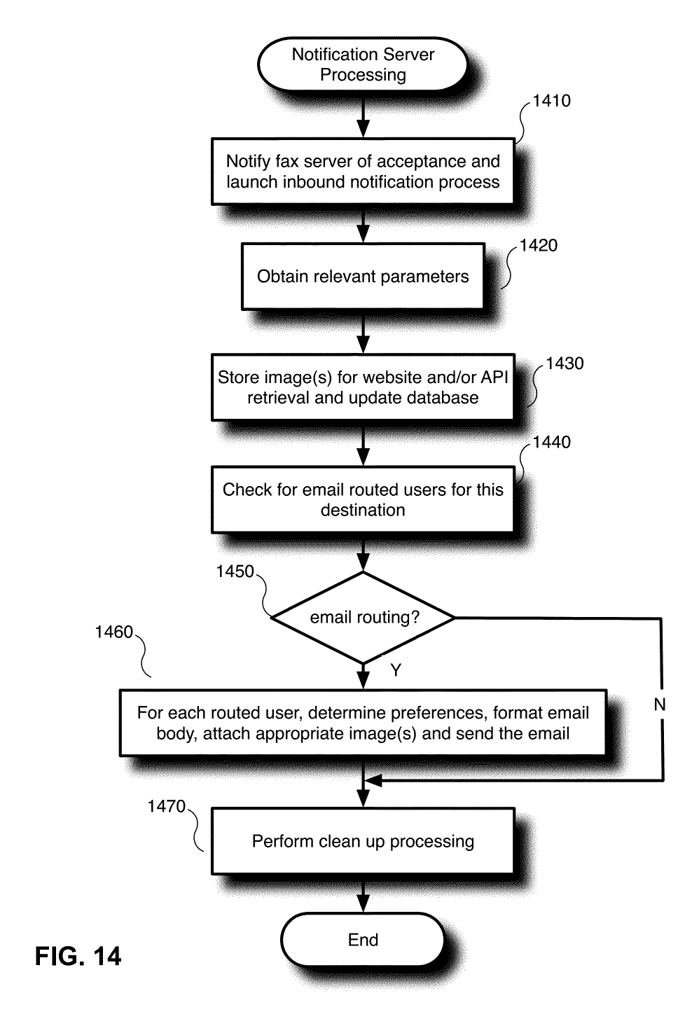

In the context of FIG. 8 it is assumed a fax server performs both conversion and customer notification processing. An alternative approach, which distributes conversion and customer notification processing between a fax server and a notification server, is now described with reference to FIG. 13 and FIG. 14. It is to be noted that a further alternative approach may shift both conversion and customer notification processing from the fax server to the notification server.

FIG. 13 is a flowchart illustrating conversion and notification/delivery processing in accordance with another embodiment of the present invention. In one embodiment, the steps described with reference to FIG. 13 are performed within block 680 of FIG. 6 by a fax server selected at block 640 of FIG. 6.

At block 1310, a fax call has been successfully received and a backup of the original TIFF image representing the received fax content is stored.

At block 1320, relevant parameters are obtained, a temporary storage location is setup and a unique file ID is generated. According to one embodiment, processing performed at block 1320 may generally follow the steps described above with referenced to FIG. 10.

At block 1330, the original TIFF image is converted to a PDF. Those skilled in the art will appreciate that the original TIFF image may also be converted to one or more additional file formats as desired. For example, the original TIFF image may also or alternatively be converted into one or more of a JPEG file, an ASCII text file, PCX files, a DCX file, a PostScript file and/or other supported file formats, including, but not limited to, bit map or raster graphics file formats.

At decision block 1340, it is determined whether the original TIFF image has been compressed using Joint Bi-level Image Experts Group (JBIG) encoding (e.g., JBIG1 or JBIG2). If so, then processing continues with block 1350; otherwise, processing branches to block 1360.

At block 1350, the original TIFF image, which has been determined to include JBIG encoding is converted to remove the JBIG encoding to accommodate client-side TIFF viewers, which typically do not support JBIG-encoded TIFFs. After block 1350, processing continues with block 1370.

At block 1360, the original TIFF image, which has been determined not to include JBIG encoding is used and no further processing of the original TIFF image is performed. After block 1360, processing continues with block 1370.

At block 1370, the original TIFF image or the converted original TIFF image and the one or more additional files created based on the original TIFF image (collectively, the fax files) are stored and the database is updated. According to one embodiment, the fax files and log file are stored in the paths generated at block 1320. The locations of the fax files and log file may also be stored to the database for use by the selected notification server to perform customer notification processing.

At block 1380, a request to perform customer notification is submitted to the least-loaded notification server. In one embodiment, the request from the fax server to the selected notification server may be made by way of placing a request on a request queue of the selected notification server that is maintained within data store 290. Alternatively, the fax server may communicate directly with the selected notification server.

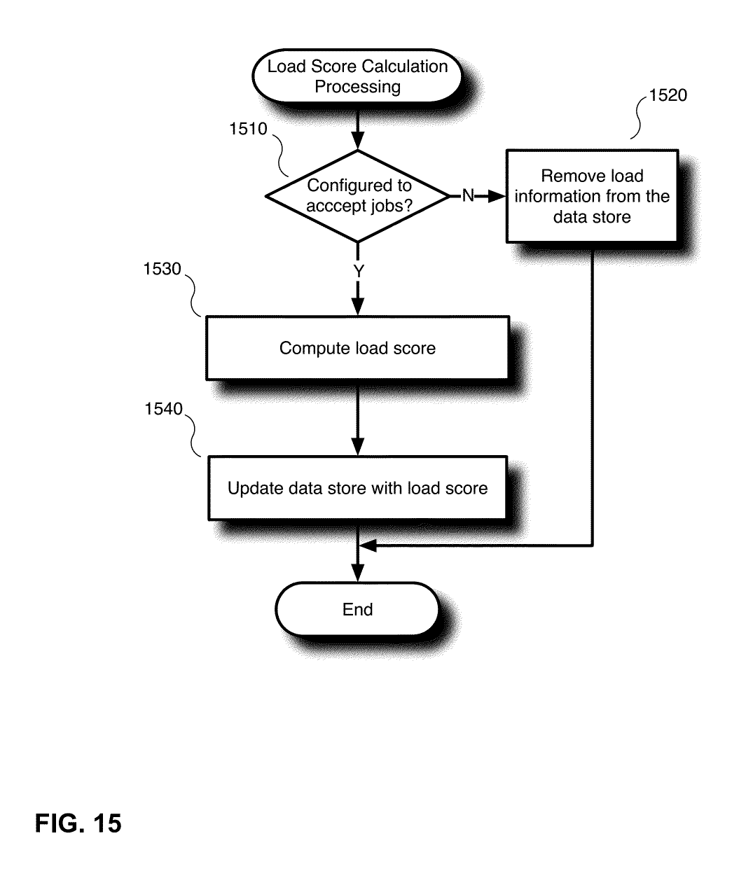

According to one embodiment, load information for notification servers (e.g., notification servers 342a-n) is first obtained to make the determination regarding the least-loaded notification server. In one embodiment, the current load information for the notification servers is periodically calculated and reported by the individual notification servers and stored in a centralized database (e.g., data store 290) as described further below with reference to FIG. 15. In such an embodiment, the current load information is gathered by requesting the most recently reported load information from the centralized database. Various alternative methods for gathering current load information will be understood by those of ordinary skill in the art. For example, the fax server attempting to identify the least loaded notification server may poll the notification servers directly for their current load information at the time when such information is needed.

At decision block 1390, a determination is made regarding whether the selected notification server has accepted the request. As above, this communication between the fax server and the selected notification server may be direct or indirect via data store 290. If the request is accepted by the selected notification server, then fax server processing is complete; otherwise, processing loops back to block 1380 for selection of a least-loaded notification server from a candidate set of notification servers excluding the previously selected notification server. This process continues until a notification server has been selected that accepts the request or until a configurable or predetermined number of tries has been made.

FIG. 14 is a flowchart illustrating notification server inbound fax processing in accordance with an embodiment of the present invention. Prior to block 1410, it is assumed that a fax server has issued a processing request to a notification server and the notification server has received the processing request. At block 1410, the notification server notifies the requesting fax server of its acceptance of the processing request and launches an inbound fax notification process. If communications between the fax server and notification server are by way of the database, the acceptance may be communicated to the fax server by updating the processing request to mark it as accepted. Alternatively, separate message queues may be maintained for each fax server within the centralized database and the notification server may place an accept message on the message queue of the requesting fax server. Further still, the notification server may run a web server or other network-accessible program/daemon with which the fax server communicates.

At block 1420, the notification server obtains relevant parameters/files/information to perform notification processing. In one embodiment, this includes gathering temporary fax files (e.g., TIFF, PDF, etc.), the logfile, source and destination of the fax from the database, pulling the fax call start time from the logfile and obtaining the subscriber's (organization's) preferred fax delivery format(s).

At block 1430, the appropriate fax files are stored for website and/or API retrieval based on the preferred fax delivery format(s) identified in block 1420. At this point, a fax received record may also be added to the database.

At block 1440, a check is made for the existence of email-routed users for the destination of the fax.

At decision block 1450, it is determined if any users are to receive this fax by email. If so, then processing continues with block 1460; otherwise, processing branches to block 1470.

At block 1460, for each email-routed user, email delivery preferences are determined, the email body is formatted, appropriate fax files are attached and the email is sent. According to one embodiment and as described above, email delivery preferences include, but are not limited to, delivery of an email notification with an embedded link from which the fax can be retrieved or delivery of the fax as an email attachment (with or without password protection or PGP encryption).

At block 1470, clean up processing is performed. According to one embodiment, this includes removing the temporary logfile and fax file copies and removing the processing request issued by the fax server from the database. At this point, notification server processing is complete for the processing request at issue.

FIG. 15 is a flowchart illustrating load score calculation processing in accordance with an embodiment of the present invention. For simplicity and sake of brevity, FIG. 15 illustrates one cycle of load score calculation processing performed by a single notification server in connection with load score calculation processing. It is to be understood that all notification servers may be concurrently performing such processing and that such processing may be periodically triggered as a result of expiration of a timer (e.g., every 5 to 10 seconds) or responsive to some other event in the Internet fax system (e.g., a request for load information from a fax server, completion of a notification process regarding a received fax or the like).

At decision block 1510, the notification server determines whether it is configured to accept processing requests from fax servers. This determination may be performed with reference to configuration information set by an administrator of the Internet fax system, for example. According to one embodiment, a notification server may be configured not to select jobs by creating a flag file (e.g., /tmp/oor) on the notification server to communicate to the notification server that it is out of rotation. If the notification server is currently configured to accept jobs, then the load score calculation processing continues with block 1530. If the notification server is not currently configured to accept jobs, then the load score calculation processing branches to block 1520.

At block 1520, this notification server is removed from consideration for processing requests by fax servers. In one embodiment, any existing load information for this notification server is removed from data store 290 to preclude selection of this notification server by a fax server for performing conversion and/or notification processing. Alternatively, the load score for this notification server may be set to a value, such as the highest load score, to indicate this notification server's unavailability to handle processing requests. Load score calculation processing is then terminated until the next load score calculation processing cycle is triggered.

At block 1530, the load score for this imaging system is calculated. In one embodiment, the load score is based on the number of jobs currently in-process on the imaging system, the current CPU load and the amount of memory currently in use. According to one embodiment, the load score is calculated in accordance with the following equation:

A×(number of currently active inbound notification processes)+B×(CPU load)+C×(megabytes of memory used)
where,
A is a constant value between 0.5 and 5 (e.g., 1).
B is a constant value between 5 and 20 (e.g., 10).
C is a constant value between 0 and 1 (e.g., 0.01).
   Those skilled in the art will appreciate various alternative calculations can be used. For example, the constants A, B and/or C can be adjusted as appropriate to suit a particular implementation or imaging system configuration.

At block 1540, the notification server updates data store 290 with the newly calculated load score. Notably, while the present example is described assuming each notification server gathers load information (e.g., active inbound notification processes, CPU load and memory used), in alternative embodiments, a process external to the notification servers may be provided with access to load information and may perform the actual load score calculation processing and/or reporting to data store 290 on behalf of the notification servers.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving, at a telecommunications system of an Internet fax system, an inbound fax call having associated therewith a source address, a destination address and a fax signal, wherein the destination address corresponds to a particular subscriber of the Internet fax system.
switching, by the telecommunications system, the inbound fax call to a private branch exchange (PBX) of a plurality of PBXs within the Internet fax system;
causing, by the PBX, the inbound fax call to be switched to a fax server of a plurality of fax servers within the Internet fax system;
translating, by the fax server, the fax signal into a plurality of digital representations;
for each notification server of a plurality of notification servers, calculating a load score based on one or more of a processor load associated with the notification server, a memory load associated with the notification server and a number of currently active inbound notification processes associated with the notification server;
selecting, by the fax server, a notification server of the plurality of notification servers based on their respective load scores; and
causing, by the fax server, one or more of the plurality of digital representations to be delivered or otherwise made available to one or more users associated with the particular subscriber by requesting the selected notification server to perform user notification processing.

2. The method of claim 1, wherein said switching, by the telecommunications system, the inbound fax call to a PBX further comprises performing round-robin load balancing among the plurality of PBXs.

3. The method of claim 1, wherein said causing, by the PBX, the inbound fax call to be switched to a fax server of a plurality of fax servers within the Internet fax system further comprises calling a digital access cross connect system (DACS) logically interposed between the PBX and the fax server.

4. The method of claim 1, further comprising determining, by the notification server, a delivery method to employ in connection with delivery of the one or more digital representations to the one or more users based on the destination address or user account specific preferences associated with the one or more users.

5. The method of claim 4, wherein the determined delivery method comprises one or more of (i) electronic mail (email) delivery, (ii) delivery via a web site associated with the Internet fax system and (iii) delivery via an application programming interface (API) associated with the Internet fax system.

6. The method of claim 1, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.

7. A non-transitory computer-readable storage medium tangibly embodying a set of instructions, which when executed by one or more processors of a plurality of computer systems of an Internet fax system, cause the one or more processors to perform a method comprising:
receiving, at a telecommunications system of the Internet fax system, an inbound fax call having associated therewith a source address, a destination address and a fax signal, wherein the destination address corresponds to a particular subscriber of the Internet fax system.
switching, by the telecommunications system, the inbound fax call to a private branch exchange (PBX) of a plurality of PBXs within the Internet fax system;
causing, by the PBX, the inbound fax call to be switched to a fax server of a plurality of fax servers within the Internet fax system;
translating, by the fax server, the fax signal into a plurality of digital representations;
for each notification server of a plurality of notification servers, calculating a load score based on one or more of a processor load associated with the notification server, a memory load associated with the notification server and a number of currently active inbound notification processes associated with the notification server;
selecting, by the fax server, a notification server of the plurality of notification servers based on their respective load scores; and
causing, by the fax server, one or more of the plurality of digital representations to be delivered or otherwise made available to one or more users associated with the particular subscriber by requesting the selected notification server to perform user notification processing.

8. The non-transitory computer-readable storage medium of claim 7, wherein said switching, by the telecommunications system, the inbound fax call to a PBX further comprises performing round-robin load balancing among the plurality of PBXs.

9. The non-transitory computer-readable storage medium of claim 7, wherein said causing, by the PBX, the inbound fax call to be switched to a fax server of a plurality of fax servers within the Internet fax system further comprises calling a digital access cross connect system (DACS) logically interposed between the PBX and the fax server.

10. The non-transitory computer-readable storage medium of claim 7, wherein the method further comprises determining, by the notification server, a delivery method to employ in connection with delivery of the one or more digital representations to the one or more users based on the destination address or user account specific preferences associated with the one or more users.

11. The non-transitory computer-readable storage medium of claim 10, wherein the determined delivery method comprises one or more of (i) electronic mail (email) delivery, (ii) delivery via a web site associated with the Internet fax system and (iii) delivery via an application programming interface (API) associated with the Internet fax system.

12. The non-transitory computer-readable storage medium of claim 7, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.

16. An Internet fax system comprising:
a plurality of private branch exchanges (PBXs);
a plurality of digital access cross connect systems (DACS)
a plurality of fax servers associated with each of the plurality of DACS;
a plurality of notification servers configured to deliver or otherwise cause to be made available digital representations of received facsimiles to one or more users associated with a subscriber of the Internet fax system to which the received facsimiles are directed;
a telecommunications system configured to receive an inbound fax call and switch the inbound fax call to a PBX of the plurality of PBXs, the inbound fax call having associated therewith a source address, a destination address and a fax signal, wherein the destination address corresponds to a particular subscriber of the Internet fax system;
wherein the PBX switches the inbound fax call to a DACS of the plurality of DACS;
wherein the DACS switches the inbound fax call to a fax server of the plurality of fax servers;
wherein each of the plurality of notification servers calculates a load score based on one or more of a processor load associated with the notification server, a memory load associated with the notification server and a number of currently active inbound notification processes associated with the notification server; and
wherein the fax server:
translates the fax signal into a plurality of digital representations;
selects a notification server of the plurality of notification servers based on their respective load scores; and
causes one or more of the plurality of digital representations to be delivered or otherwise made available to one or more users associated with the particular subscriber by requesting the selected notification server to perform user notification processing.

17. The Internet fax system of claim 16, wherein the telecommunications system is further configured to perform round-robin load balancing among the plurality of PBXs.

18. The Internet fax system of claim 16, wherein the selected notification server is further configured to determine a delivery method to employ in connection with delivery of the digital representation to one or more users associated with the particular subscriber based on the destination address or user account specific preferences associated with the one or more users.

19. The Internet fax system of claim 18, wherein the determined delivery method comprises one or more of (i) electronic mail (email) delivery, (ii) delivery via a web site associated with the Internet fax system and (iii) delivery via an application programming interface (API) associated with the Internet fax system.

20. The Internet fax system of claim 16, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.

21. A method comprising:
receiving, at a telecommunications system of an Internet fax system, an inbound fax call having associated therewith a source address, a destination address and a fax signal, wherein the destination address corresponds to a particular subscriber of the Internet fax system.
switching, by the telecommunications system, the inbound fax call to a private branch exchange (PBX) of a plurality of PBXs within the Internet fax system;
causing, by the PBX, the inbound fax call to be switched to a fax server of a plurality of fax servers within the Internet fax system;
receiving, by the fax server, the fax signal in a form of a native fax format;
for each notification server of a plurality of notification servers, calculating a load score based on one or more of a processor load associated with the notification server, a memory load associated with the notification server and a number of currently active inbound notification processes associated with the notification server;
selecting, by the fax server, a notification server of the plurality of notification servers based on their respective load scores;
causing, by the fax server, the selected notification server to perform user notification processing, including translating the native fax format into a plurality of digital representations; and
causing, by the selected notification server, one or more of the plurality of digital representations to be delivered or otherwise made available to one or more users associated with the particular subscriber.

22. The method of claim 21, wherein said switching, by the telecommunications system, the inbound fax call to a PBX further comprises performing round-robin load balancing among the plurality of PBXs.

23. The method of claim 21, wherein said causing, by the PBX, the inbound fax call to be switched to a fax server of a plurality of fax servers within the Internet fax system further comprises calling a digital access cross connect system (DACS) logically interposed between the PBX and the fax server.

24. The method of claim 21, further comprising determining, by the notification server, a delivery method to employ in connection with delivery of the one or more digital representations to the one or more users based on the destination address or user account specific preferences associated with the one or more users.

25. The method of claim 24, wherein the determined delivery method comprises one or more of (i) electronic mail (email) delivery, (ii) delivery via a web site associated with the Internet fax system and (iii) delivery via an application programming interface (API) associated with the Internet fax system.

26. The method of claim 21, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.

27. A non-transitory computer-readable storage medium tangibly embodying a set of instructions, which when executed by one or more processors of a plurality of computer systems of an Internet fax system, cause the one or more processors to perform a method comprising:
receiving, at a telecommunications system of an Internet fax system, an inbound fax call having associated therewith a source address, a destination address and a fax signal, wherein the destination address corresponds to a particular subscriber of the Internet fax system.
switching, by the telecommunications system, the inbound fax call to a private branch exchange (PBX) of a plurality of PBXs within the Internet fax system;
causing, by the PBX, the inbound fax call to be switched to a fax server of a plurality of fax servers within the Internet fax system;
receiving, by the fax server, the fax signal in a form of a native fax format;
for each notification server of a plurality of notification servers, calculating a load score based on one or more of a processor load associated with the notification server, a memory load associated with the notification server and a number of currently active inbound notification processes associated with the notification server;
selecting, by the fax server, a notification server of the plurality of notification servers based on their respective load scores;
causing, by the fax server, the selected notification server to perform user notification processing, including translating the native fax format into a plurality of digital representations; and
causing, by the selected notification server, one or more of the plurality of digital representations to be delivered or otherwise made available to one or more users associated with the particular subscriber.

28. The non-transitory computer-readable storage medium of claim 27, wherein said switching, by the telecommunications system, the inbound fax call to a PBX further comprises performing round-robin load balancing among the plurality of PBXs.

29. The non-transitory computer-readable storage medium of claim 27, wherein said causing, by the PBX, the inbound fax call to be switched to a fax server of a plurality of fax servers within the Internet fax system further comprises calling a digital access cross connect system (DACS) logically interposed between the PBX and the fax server.

30. The non-transitory computer-readable storage medium of claim 27, wherein the method further comprises determining, by the notification server, a delivery method to employ in connection with delivery of the one or more digital representations to the one or more users based on the destination address or user account specific preferences associated with the one or more users.

31. The non-transitory computer-readable storage medium of claim 30, wherein the determined delivery method comprises one or more of (i) electronic mail (email) delivery, (ii) delivery via a web site associated with the Internet fax system and (iii) delivery via an application programming interface (API) associated with the Internet fax system.

32. The non-transitory computer-readable storage medium of claim 27, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.

36. An Internet fax system comprising:
a plurality of private branch exchanges (PBXs);
a plurality of digital access cross connect systems (DACS)
a plurality of fax servers associated with each of the plurality of DACS;
a plurality of notification servers configured to translate each received facsimile into to multiple digital representations and deliver or otherwise cause to be made available a subset of multiple digital representations to one or more users associated with a subscriber of the Internet fax system to which the received facsimiles are directed;
a telecommunications system configured to receive an inbound fax call and switch the inbound fax call to a PBX of the plurality of PBXs, the inbound fax call having associated therewith a source address, a destination address and a fax signal, wherein the destination address corresponds to a particular subscriber of the Internet fax system;
wherein the PBX switches the inbound fax call to a DACS of the plurality of DACS;
wherein the DACS switches the inbound fax call to a fax server of the plurality of fax servers;
wherein each of the plurality of notification servers calculates a load score based on one or more of a processor load associated with the notification server, a memory load associated with the notification server and a number of currently active inbound notification processes associated with the notification server; and
wherein the fax server:
receives the fax signal in a form of a native fax format;
selects a notification server of the plurality of notification servers based on their respective load scores; and
causes one or more of a plurality of digital representations to be delivered or otherwise made available to one or more users associated with the particular subscriber by requesting the selected notification server to perform user notification processing, including translating the native fax format into the plurality of digital representations.

37. The Internet fax system of claim 36, wherein the telecommunications system is further configured to perform round-robin load balancing among the plurality of PBXs.

38. The Internet fax system of claim 36, wherein the selected notification server is further configured to determine a delivery method to employ in connection with delivery of the digital representation to one or more users associated with the particular subscriber based on the destination address or user account specific preferences associated with the one or more users.

39. The Internet fax system of claim 38, wherein the determined delivery method comprises one or more of (i) electronic mail (email) delivery, (ii) delivery via a web site associated with the Internet fax system and (iii) delivery via an application programming interface (API) associated with the Internet fax system.

40. The Internet fax system of claim 36, wherein the load score is calculated in accordance with an equation as follows:
A×(the number of currently active inbound notification processes)+B×(CPU load)+C×(units of memory used)
where,
A is a constant value between 0.5 and 5;
B is a constant value between 5 and 20; and
C is a constant value between 0 and 1.
